(19) United States
(12) Patent Application Publication
(10) Pub. No.: US 2026/0171814 A1
(43) Pub. Date: Jun. 18, 2026

(54) METHOD FOR CHARGING A BATTERY PACK

(71) Applicant: Andreas Stihl AG & Co. KG, Waiblingen (DE)

(72) Inventors: Leonard Mattheis, Waiblingen (DE); Joscha Daniel Staub, Weinstadt (DE); Daniel Sauerteig, Kemen im Remstal (DE); Thomas Heinrich, Leutenbach (DE)

(21) Appl. No.: 19/422,264

(22) Filed: Dec. 16, 2025

(30) Foreign Application Priority Data
Dec. 17, 2024 (DE) 10 2024 138 392.5
Dec. 17, 2024 (DE) 10 2024 138 393.2
Dec. 17, 2024 (DE) 10 2024 138 394.1

(51) Int. Cl. H02J 7/50

(52) U.S. Cl. CPC H02J 7/50

(57) ABSTRACT

A method is for charging a first and a second battery pack using a charger. The charger has a first interface, a second interface, and an electronics unit for providing a charging power at the first and/or the second interface. The controller detects that the first battery pack is connected to the first interface at a first time and the second battery pack is connected to the second interface at a second time. The controller controls the power electronics unit depending on the detected times and a predetermined time span such that the charging power is output on the first interface to charge the first battery pack and/or on the second interface to charge the second battery pack, wherein primarily the first battery pack is charged if the first time is before the second time by more than the predetermined time span.

### CROSS-REFERENCE TO RELATED APPLICATIONS

This application claims priority of German patent application nos. 10 2024 138 392.5, 10 2024 138 393.2 and 10 2024 138 394.1, all filed Dec. 17, 2024, the entire contents of which are incorporated herein by reference.

### TECHNICAL FIELD

The disclosure relates to methods for charging a first battery pack and a second battery pack using a charger. The charger includes a first interface for connecting the first battery pack and a second interface for connecting the second battery pack. A charging power is fed to the interfaces via a power electronics unit. A controller detects the connection of a battery pack to an interface and feeds a matched charging power for charging the battery pack to the first and/or the second interface.

### BACKGROUND

Such chargers having at least two battery bays having an interface for charging battery packs are used in particular to ensure continuous operation of a battery powered device. If the battery pack of the battery powered device is empty, it is exchanged for a battery pack which has been charged in the meantime in the charger. Operation of multiple battery-powered devices while using only one charger is thus also ensured.

Known chargers are configured such that after a battery pack is inserted into a battery bay in each case, both battery packs are charged simultaneously. Depending on the state of charge of a battery pack, this results in long charging times. The long charging time can have the result that the user removes a battery pack prematurely from the charger and thus has only partially charged battery packs available for continuing his work. This results in shorter operating times of the battery-powered device and more frequent changes of the battery pack.

### SUMMARY

It is an object of the disclosure to specify a method for charging battery pack using a charger, using which complete charging of a battery pack is possible within a short charging time, in order to thus enable continued work with battery-powered devices. According to the further object, a controller and a charger for carrying out the method are to be specified.

To achieve the object, a first method is provided, in which the controller detects the first time, at which the first battery pack is connected to the first interface. Furthermore, the controller detects the time at which the second battery pack is connected to the second interface. The controller controls the power electronics unit depending on the detected times and a predetermined time span such that the charging power is output on the first interface for charging the first battery pack and/or on the second interface for charging the second battery pack. The first method is configured so that primarily the first battery pack is charged at the first interface if the first time is before the second time by more than a predetermined time span. In other words, the first battery pack is primarily charged at the first interface if a predetermined time span passes after the connection of the first battery pack to the first interface before the second battery pack is connected to the second interface.

The power electronics unit will therefore initially output the charging power on the first interface to charge the first battery pack.

If the first battery pack can be charged at the first interface using a charging power which corresponds to the maximum charging power of the power electronics unit, no charging power is thus fed to the second interface. If the charging power of the charging electronics unit is greater than the charging power fed to the first battery pack at the first interface, the still remaining residual charging power is output on the second interface to charge the second battery pack.

According to the first method, one battery pack is preferably charged in the charger, so that at least one first completely charged battery pack for continuing his work is available to the user after a short charging time.

In an embodiment of the first method, the user can influence the method for charging the battery packs if the second time of connecting the second battery pack to the second interface is within the predetermined time span after the first time. If the user, after plugging a first battery pack into a first battery bay, only plugs the second battery pack into the second battery bay when the predetermined time span has expired, the first and the second battery pack are charge sequentially, in parallel, or also simultaneously depending on the requested charging current of the battery packs.

In an embodiment of the first method, the controller detects the permissible maximum charging current of the first battery pack connected to the first interface. The controller will initially use the charging power for the primary charging of the first battery pack with up to its maximum charging current and feed the charging power to the first battery pack. Since the first battery pack is charged using its maximum permissible charging current, the first battery pack can be completely charged within only a short charging time, in particular can be charged to its maximum charging end voltage.

Depending on the time sequence of the plugging of the battery packs into the battery bays and the accompanying connection of the battery pack to an interface, therefore either primarily the first battery pack is charged or the first battery pack and the second battery pack are charged simultaneously.

In an embodiment of the first method, it is provided that the second interface is fed a residual charging power if the fraction of the available charging power required for the primary charging of the first battery pack using up to its maximum charging current is less than the total charging power available overall from the power electronics unit. Rapid charging of the second battery pack can thus also be ensured.

According to the first method, it is provided that the first and the second battery pack are charged using a variable charging power. If a high charging power of the power electronics unit is available, which cannot be exhausted in the primary charging of the first battery pack, the remaining residual charging power can be used on the second interface for charging the second battery pack. It can thus be advantageous to output more than 50%, in particular more than 80%, very particularly 100% of the charging power on the first interface in order to primarily charge the first battery pack.

In an embodiment of the first method, it is expedient to raise the charging power output on the second interface of the second battery pack if the first battery pack at the first interface is charged by more than 50%, in particular by more than 80% or by more than 90%. In particular, the charging power is increased on the second interface of the second battery pack when the first battery pack at the first interface is charged by more than 98%, very particularly by more than 99%.

The predetermined time span is advantageously in a range from 0 seconds to 1 minute. The predetermined time span is expediently in a range from 0.1 seconds to 20 seconds, in particular in a range from 0.5 seconds to 10 seconds, very particularly at 5 seconds.

In the first method, it can be provided that the temperature of a battery pack connected to an interface is detected. If the detected temperature of a battery pack is outside a predetermined temperature window, the charging power of the battery pack connected to the interface is lowered or reduced to “zero”. Charging power is only output via the interface of the battery pack again when the temperature of the battery pack is in the provided temperature window. For a lithium-ion based battery pack, charging in a temperature window from +5° C. to +45° C. is expedient. In the working device, discharging of the battery pack in a temperature range from −10° C. to +55° C. is permissible in operation. A battery pack based on lithium iron phosphate can be charged in a temperature range from 0° C. to 45° C. and discharged in a temperature range from −25° C. to 60° C. The battery pack can be cooled or heated depending on the detected temperature of the connected battery pack. For this purpose, a cooling air flow or a warm air flow can be fed to the battery bay of the charger into which the battery pack is inserted.

According to the first method, it can additionally be provided—in particular independently of the time span of the connection of the battery pack to the interfaces—that the state of charge of the first battery pack connected to the first interface and the state of charge of the second battery pack connected to the second interface are detected. The states of charge of the connected battery packs are compared to one another and the charging power flowing to one battery pack is adjusted depending on the comparison of the states of charge of the battery packs. The battery pack having the lower state of charge can thus be fed a higher charging power in order to ensure its rapid charging. Independently of the time sequence of the connection of the battery packs to the interfaces, a higher charging power can thus also flow to the interface at which the battery pack having the higher state of charge is connected. In this way, a completely charged battery pack for continuing his work can be made available to the user within a short time span.

According to a further achievement of the object, in a second method, the first battery pack is charged via the first interface and the second battery pack is charged via the second interface using a first charging power or using a second charging power. It is provided here that the first charging power is greater than the second charging power. If the first charging power is fed to the first interface to charge the first battery pack, the controller is configured to detect an operating parameter of the active charging procedure at the first interface and to compare it to a limiting value stored in the controller. The controller will feed a second charging power to the second interface to charge the second battery pack depending on the result of the comparison.

The second method is configured so that a maximum charging power is output at the first interface in order to preferably charge the first battery pack connected to the first interface. It can be recognized here by the detection of the operating parameter of the active charging procedure whether the battery pack connected to the first interface can use the provided power. If the battery pack connected to the first interface can no longer use the available charging power, the second interface is fed the second charging power, which can correspond to the charging power not usable at the first interface. Since the first battery pack is charged using its maximum permissible charging current, the first battery pack can be charged to its maximum capacity within only a short charging time.

The controller uses, as the operating parameter of the active charging procedure, the actual value of a charging current flowing to the battery pack. This actual value is detected by the controller and compared to the limiting value stored in the controller. The limiting value stored in the controller is a current limiting value. The absolute value of the current limiting value can be between 12 A and 48 A, in particular at 24 A, very particularly at 12 A. Other absolute values of the current limiting value can also be advantageous, such as 20 A. The charging current is simple to detect and can be compared to a current limiting value without great technical effort.

According to the second method, the controller will feed the second charging power to the second interface and a second battery pack connected thereto if the actual value of the charging current falls below the stored limiting value.

The controller detects a permissible maximum charging current of the first battery pack connected to the first interface, and feeds the first interface the charging power for charging the first battery pack at up to the permissible maximum charging current to the first battery pack. The second interface is fed a residual charging power if the fraction of a total charging power provided by the power electronics unit required for charging the first battery pack with up to the permissible maximum charging current is less than the total charging power provided by the power electronics unit.

The charging power fed to the second interface to charge the second battery pack is increased if the first battery pack connected to the first interface is charged by more than 50%. In particular, the charging power fed to the second interface to charge the second battery pack is increased if the first battery pack connected to the first interface is charged by more than 80%, in particular by more than 90% or by more than 98%, very particularly by more than 99%.

In an embodiment of the second method, it is provided that the temperature of a battery pack connected to an interface is detected. If the detected temperature of a battery pack connected to an interface is outside a predetermined temperature window, the charging power of the battery pack connected to the interface is lowered or reduced to “zero”. A charging power is output again via the interface of the battery pack only when the temperature of the battery pack is again in the provided temperature window. Rapid and nonetheless gentle charging of a battery pack can thus be achieved.

It can be advantageous to cool or heat the battery pack depending on the detected temperature of the connected battery pack. For this purpose, a cooling air flow or a warm air flow can be fed to the battery bay of the charger into which the battery pack is inserted.

According to the second method, it can be provided that the state of charge of the first battery pack connected to the first interface and the state of charge of the second battery pack connected to the second interface are detected. The states of charge of the connected battery packs are compared to one another and the charging power flowing to a battery pack is adjusted depending on the comparison of the states of charge of the battery pack. A higher charging power can thus be fed to the battery pack having the lower state of charge in order to ensure its rapid charging.

In a particular manner, the second method can be configured such that a higher charging power flows to the battery pack which has the higher state of charge. In this way, a completely charged battery pack for continuing his work can be made available to the user within a short time span.

According to a further achievement of the object, in a third method, the first battery pack is charged via the first interface and the second battery pack is charged via the second interface using a charging power. To enable a matched efficient charging of connected battery packs, the controller detects operating data of the battery pack connected in each case to an interface. The operating data are used by the controller to determine or calculate the remaining charge of the battery pack connected to an interface. The controller compares the detected operating data of the first and the second battery pack with one another in order to establish which of the connected battery packs contains the greater remaining charge of electrical energy. After the evaluation of the comparison of the operating data carried out by the controller, primarily the battery pack having the greater remaining charge is charged.

Due to the evaluation of the comparison and the prioritization resulting therefrom of the battery packs according to their remaining charge, the power electronics unit will provide a greater charging power to the battery pack having the greater remaining charge in order to ensure its rapid charging. It is also accepted here that no or only a very small charging power flows to a second connected battery pack until the first battery pack has reached a predetermined state of charge.

Since the first battery pack is preferably charged, the first battery pack reaches a maximum charged amount of energy within only a short charging time, so that a charged battery pack for continuing his work is available to a user.

In an embodiment of the third method, the controller will detect and evaluate the permissible maximum charging current of the battery packs connected to the interfaces. Depending on the evaluation of the operating data and the remaining charge resulting therefrom, the controller will primarily use the charging power to charge the battery pack which has the greater remaining charge. The battery pack having the greater remaining charge is charged up to its maximum charging current.

In an embodiment of the third method, it is provided that the second interface is fed a residual charging power if the fraction of the charging power required to charge the prioritized first battery pack using up to the permissible maximum charging current is less than the total charging power provided by the power electronics unit. In spite of the prioritized charging of the first battery pack, if an excess of available total charging power exists, the second battery pack can be charged using a remaining residual charging power. The total power of the power electronics unit of the charger can thus be used and the battery packs can be charged accordingly.

Different characteristic values can be used as operating data of the battery pack for determining a remaining charge. These operating data can also be combined with one another for simple determination of a remaining charge.

The operating data of the battery packs can thus include their current remaining voltages, and the controller can primarily charge the battery pack having the greater remaining voltage.

The operating data advantageously include the amounts of energy to be absorbed by the battery packs per unit of time. The controller will then primarily charge the battery pack having the greater amount of energy to be absorbed per unit of time.

According to the third method, it is provided that the temperature of a battery pack connected to an interface is detected as operating data. If the detected temperature of a battery pack connected to an interface is outside a predetermined temperature window, the charging power of the battery pack connected to the interface is lowered or reduced to “zero”. A charging power is output again via the interface of the battery pack only when the temperature of the battery pack lies in the provided temperature window again. Rapid and nonetheless gentle charging of a battery pack can thus be achieved.

It can be advantageous to cool or heat the battery pack depending on the detected temperature of the connected battery pack. For this purpose, a cooling air flow or a warm air flow can be fed to the battery bay of the charger into which the battery pack is inserted.

In an embodiment of the method, it is provided that the controller maintains a charging procedure set once until complete charging of the battery pack. It can be expedient for the controller to update the operating parameters of the battery packs after a predetermined time span and to adjust the charging power fed to the interfaces according to the updated operating parameters. Gentle, rapid charging of a battery pack is thus ensured via a charging procedure.

To carry out the method, a controller for a charger having a first interface for charging a first battery pack and a second interface for charging a second battery pack and a power electronics unit for providing a charging power is provided, wherein the controller is configured to carry out one of the above-described methods.

A charger operated using one of the methods includes a first interface for charging a first battery pack and a second interface for charging a second battery pack as well as a power electronics unit for providing a charging power and a controller. The controller is configured to carry out one of the above-described methods.

The first interface for charging a first battery pack is preferably configured as a battery bay for the insertion of the battery pack. Accordingly, the second interface for charging a second battery pack is configured as a battery bay. The connection to an interface is established with the insertion of a battery pack into a battery bay.

The power electronics unit can include at least one DC/DC converter, wherein the DC/DC converter is connected to one of the first and the second interface. The power electronics unit is configured to set the charging power to the first and/or the second interface, to which the DC/DC converter is connected.

It can be advantageous for the power electronics unit to include two DC/DC converters and each of the two DC/DC converters to be connected to one of the two interfaces. The DC/DC converters can be switched individually or jointly to an interface. In particular, the power electronics unit can set the charging power to the interface to which the respective DC/DC converter is connected.

A computer program is provided to carry out the method, which includes commands that cause a controller, in particular the controller of a charger, to carry out the method steps of one or more of the methods specified above. The computer program is stored on a computer-readable medium.

### BRIEF DESCRIPTION OF DRAWINGS

The invention will now be described with reference to the drawings wherein:

FIG. 1 shows a schematic block diagram of a charger having two battery bays, a power electronics unit, and a controller for charging battery packs using two voltage regulators each having a variable power output;

FIG. 2 shows a schematic block diagram corresponding to the illustration of FIG. 1 having a power electronics unit having a voltage regulator having two variable power outputs;

FIG. 3 shows a schematic block diagram corresponding to the illustration of FIG. 1 having a power electronics unit having two voltage regulators each having a power output and a switching device between the power outputs of the voltage regulators and the battery bays;

FIG. 4 shows a schematic diagram of the charging currents output during a charging procedure via the power outputs of the power electronics unit over the charging time; and,

FIG. 5 shows a schematic flow chart for visualizing a method for regulating or switching the power outputs depending on operating parameters of the charging procedure and/or the battery packs to be charged.

### DETAILED DESCRIPTION

The description describes all specified methods, a controller 10 configured to carry out one or more of the specified methods, and a charger for carrying out one or more of the specified methods.

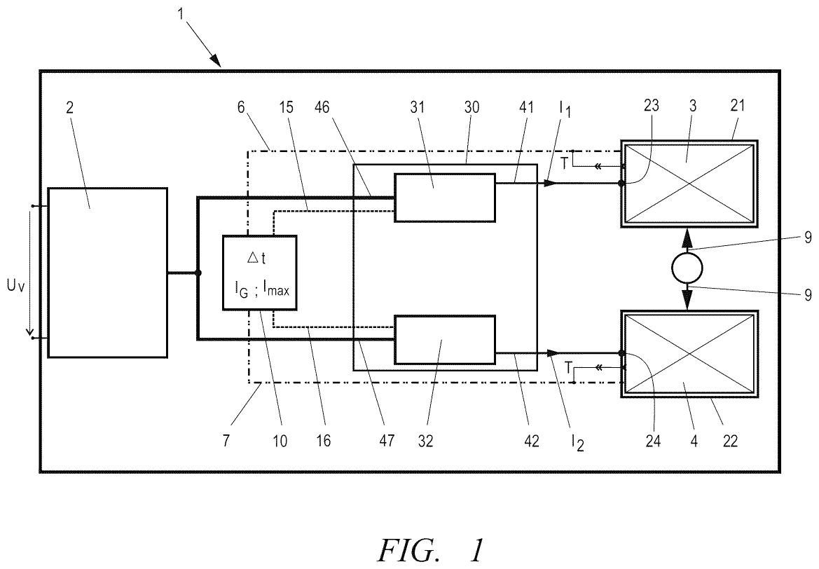

The charger 1 shown in FIG. 1 to FIG. 3 is configured to charge the battery packs 3 and 4 inserted into a battery bay 21 or 22, respectively, according to one of the methods described hereinafter. The methods include method steps which can be associated with each of the described methods. The method steps mentioned in a method can also be advantageous in combination or alone in another method.

FIG. 1 shows a charger 1 for charging at least two battery packs 3, 4. The charger 1 includes a first battery bay 21 and a second battery bay 22. A battery pack 3, 4, which is to be charged by the charger 1, is inserted into a battery bay 21, 22. Different types of battery packs can be inserted into a battery bay 21, 22, for example battery packs having a charging power of 12 A, of 24 A, of 36 A, or the like. Other charging powers such as 18 A, 20 A, or other dimensions of the charging current are also possible.

In the description, the battery pack 3 inserted into a first battery bay 21 is indicated as the first battery pack. The battery pack 4 inserted into the second battery bay 22 is designated as the second battery pack. The designations “first” and “second” serve for easier understanding of the description and the methods mentioned therein. The battery pack 4 inserted into the second battery bay can likewise be designated as the first battery pack in the sense of the description and the described methods.

The charger 1 is connected via a power supply unit 2 to a supply voltage UV. The supply voltage UV can be a public power grid having a grid voltage of, for example, 120 V, 230 V, or also 400 V.

A power electronics unit 30 is provided between the power supply unit 2 and a battery bay 21, 22, which, in the embodiment of FIG. 1, includes two voltage regulators 31, 32, which are connected on the input side to the power supply unit 2. The voltage regulators 31 and 32 are preferably configured identically. In particular, the voltage regulators 31 and 32 are buck converters or DC/DC converters, in particular power-regulated DC/DC converters or LLC converters (an LLC converter is a resonance transducer which includes three reactive components—two coils [L] and one capacitor [C]).

A power output 41 of the first voltage regulator 31 is connected to a first electrical interface 23 in the battery bay 21. Accordingly, a power output 42 of the second voltage regulator 32 is electrically connected to a second electrical interface 24 in the battery shaft 22. The voltage regulators 31 and 32 of the power electronics unit 30 are located in power branches 46 and 47 lying electrically in parallel to one another.

In FIG. 1, the voltage regulators 31, 32 are embodied as DC/DC converters. The voltage regulators are configured such that the charging powers output on their power outputs 41 and 42 can be adjusted. For this purpose, the controller 10 is connected via the control lines 15 and 16 to the voltage regulators 31 and 32. The controller 10 can thus intervene depending on the data flowing in via the communication connection 6 or 7 at the voltage regulators 31, 32, in order to perform, for example, an adjustment of the charging current I₁, I₂ and/or the charging voltage.

The controller 10 has a data transfer connection via a communication connection 6 or 7 to each of the battery bays 21, 22 or to a battery pack 3, 4 inserted into the battery bay 21, 22. The communication connection 6 or 7 is configured such that after a battery pack 3, 4 is inserted into a battery bay 21, 22, a communication with the controller 10 takes place via the communication connection 6 or 7. The characteristic data and/or operating data of the respective battery pack 3, 4 are transmitted to the controller 10 via the communication connection 6 or 7. Characteristic data can be the nominal voltage of the battery pack 3, 4, its capacitance, its chemical structure, its maximum charging current, or the like. Operating data can be the temperature, the present charging current, the present voltage of the battery pack 3, 4, or the like. The controller 10 establishes by evaluating the operating data and/or characteristic data whether a battery pack 3, 4 inserted into the battery bay 21, 22 is ready for charging.

Without intervention by the user, a battery pack inserted into a battery bay 21, 22 can be charged using a maximum charging current I_{Lmax} provided by the power electronics unit 30, so that the charging time of a battery pack 2, 3 inserted into a battery bay 21, 22 is reduced. The controller 10 of the charger 1 recognizes independently which power class the inserted battery pack 2, 3 has and feeds a maximum permissible charging current I₁, I₂ to the interface 23, 24 in the battery bay 21, 22.

The voltage regulators 31 and 32, which are preferably configured as buck converters, are advantageously configured identically. Each voltage regulator 31 or 32 in particular has an equal maximum charging current. A maximum charging current can be allocated to a battery bay 21 or 22 by the controller 10.

The charger 1 is configured such that, depending on the state of charge of the inserted battery packs 3, 4, a selection takes place of which of the two inserted battery packs 3, 4 is preferably charged. For a charging procedure, a first battery pack 3 is inserted into the battery bay 21 and a second battery pack 4 is inserted into the battery bay 22. The first battery pack 3 inserted into the battery bay 21 is connected to the interface 23 and to the communication connection 6 to the controller 10. The second battery pack 4 inserted into the battery bay 21 is connected to the interface 24 and to the communication connection 7 to the controller 10.

After the insertion of the battery packs 3, 4, the controller 10 detects the characteristic data and/or operating data of the battery packs 3 and 4 connected in each case to an interface 23 and 24 and the communication connection 6, 7. The controller determines the remaining charge of the connected battery pack 3 and 4 from these characteristic data and/or operating data of the respective connected battery pack 3 and 4.

The controller now processes and/or compares the detected operating data of the first and the second battery pack 3, 4 with one another. The operating data are used to determine the remaining charge of the respective battery pack 3 and 4 connected to an interface 23 and 24. On the basis of a comparison of the operating data and/or a remaining charge of the battery pack 3, 4 determined therefrom, the controller will set the power electronics 30 such that preferably the battery pack 3 or 4 having the greater remaining charge is charged. A completely charged battery pack can thus be provided to the user within a short time span.

In a simple manner, the controller 10 detects the permissible maximum charging current Imax of the battery packs 3 and 4 connected to the interfaces 23 and 24. The controller will use the available charging power of the charger 1 primarily to charge the battery pack 3 or 4 having the greater remaining charge in this case. The battery pack 3 or 4 having the greater remaining charge is charged in particular up to its maximum charging current Imax.

If the total charging power provided by the charging electronics unit 30 is not used in order to charge, for example, the battery pack 3 connected to the interface 23, which has the greater remaining charge, a still available residual charging power will be fed to the other, in the example the interface 24, to charge the other battery pack 4. In this way, independently of the preferred charging of a battery pack 3 or 4, the total charging power provided by the power electronics unit 30 can be used. The charger 1 is utilized with its maximum charging current I_{Lmax}.

The detected operating data of the battery packs 3 and 4 can in particular include their current battery voltages (for example their remaining voltages), wherein the controller 10 primarily, that is, preferably charges the battery pack 3 or 4 having the greater current battery voltage (remaining voltage). It can also be provided that the operating data include the amounts of energy to be absorbed per unit of time by the battery packs 3 and 4 and the controller 10 primarily charges the battery pack 3 or 4 which enables a greater amount of energy to be absorbed per unit of time.

For gentle charging of a battery pack 3, 4, its temperature is important. It is therefore provided that the operating data include the temperature T of the battery pack connected to an interface. The controller 10 will only feed a charging power at the respective interface 23, 24 to the battery pack 3, 4 if the detected temperature T of the battery pack 3, 4 is within a predetermined temperature range. Such a temperature range is also dependent on the chemical structure of the battery pack. In a lithium-ion battery pack, the temperature range is, for example, Tᵤ=+5° C. to Tₒ=+45° C. A battery pack based on lithium iron phosphate can be charged in a temperature range from Tᵤ=0° C. to Tₒ=+45° C. The controller 10 will interrupt a running charging procedure if the temperature T of the battery pack 3, 4 is outside the predetermined temperature range. The controller 10 will only continue the charging procedure of the battery pack 3, 4 when the temperature lies within the predetermined temperature range again. It can therefore be expedient to feed a medium, for example an air flow 9 for heating or cooling the battery pack 3, 4 inserted therein, to a battery bay 21, 22. Using such a medium, for example the air flow 9, the battery pack 3, 4 to be charged can be kept within a predetermined temperature range.

It is provided that the controller 10 maintains a charging procedure set once until the battery pack 3, 4 is completely charged. In particular, a charging procedure which is set once and is running is not to be interrupted. As stated above, excessive heating of the battery pack 3, 4 during the charging procedure can be unfavorable for the service life of the battery pack. It is therefore provided that in the event of excessively strong heating of the battery pack during the charging procedure, it is interrupted at least until the temperature of the battery pack 3, 4 is in the predetermined temperature range again. It can also be expedient to terminate the charging procedure in the event of excessively strong heating of the battery pack 3, 4 and indicate the termination of the charging procedure to the user.

It can also be advantageous that the controller 10 updates the operating data of the battery packs 3, 4 after a predetermined time span. For this purpose, the controller can request the operating data of the battery packs 3, 4 again via the communication connections 6, 7. The charging power fed to the individual battery packs 3 and 4 connected to the interfaces 23 and 24 can then be adjusted according to the updated operating parameters. Theoretically, this can also have the result that a battery pack 3 or 4 which is initially charged secondarily is then charged primarily, thus preferably, because the operating parameters have changed over the charging procedure.

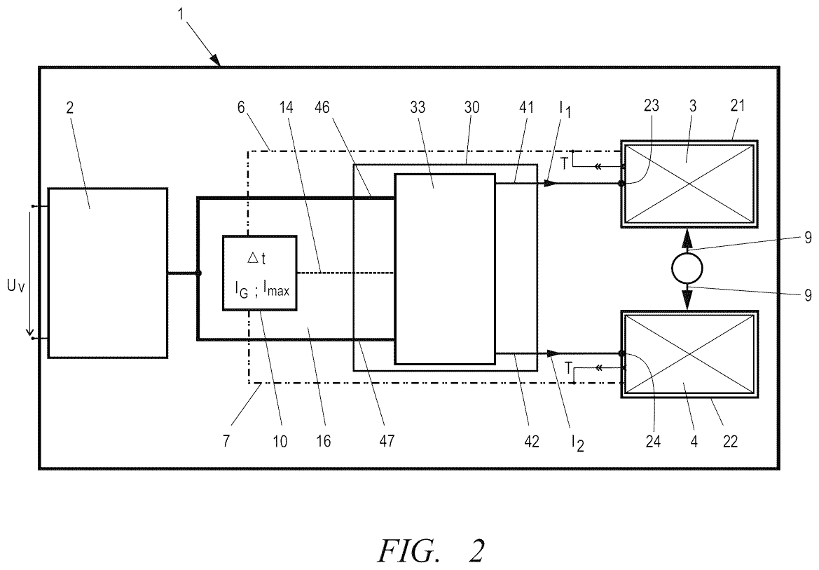

In FIG. 1, the power electronics unit 30 includes at least two voltage regulators 31, 32 configured as DC/DC converters, the charging powers of which output at the power outputs 41, 42 are variable. In FIG. 2, the power electronics unit 30 includes a voltage regulator 33 configured as a DC/DC converter, which is connected via a first power output 41 to the first interface 23 in the first battery bay 21 and using a second power output 42 to the second interface 24 in the second battery bay 22. The voltage regulator 33 is configured to set the charging power of the power outputs 41, 42 to the interfaces 23 and 24. For this purpose, the controller 10 is connected via a control line 14 to the power electronics unit 30 or the voltage regulator 33 configured as a DC/DC converter.

The fundamental function of the charger 1 shown in FIG. 2 corresponds to the method described as an example for FIG. 1. Identical parts are provided with identical reference signs.

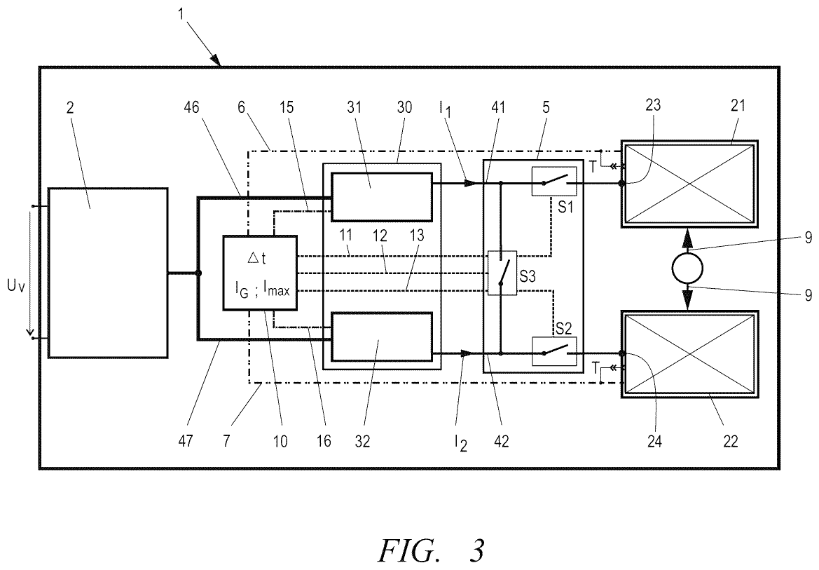

In another embodiment of the disclosure, it can be provided that in particular identically configured voltage regulators 31 and 32 are provided, which output an equal charging power at their power outputs 41, 42. The method described as an example can also be carried out with voltage regulators 31, 32 configured as DC/DC converters having nonvariable power outputs 41, 42. An embodiment of such a charger 1 is shown in FIG. 3. Identical parts are provided with identical reference signs as in FIG. 1 and FIG. 2.

The power output 41 of the voltage regulator 31 is connected via a first switching element S1 to the interface 23 in the battery bay 21. The power output 42 of the voltage regulator 32 is electrically connected via a second switching element S2 to the interface 24 in the battery bay 22. The voltage regulators 31 and 32 lie in power branches 41 and 42, which are electrically parallel to one another.

The first power output 41 of the first voltage regulator 31 and the second power output 42 of the second voltage regulator 32 are connected to one another via a third switching element S3. The connection of the power outputs 41 and 42 via the third switching element S3 lies between the power branch of the power output 41 from the voltage regulator 31 to the first switching element S1 and the power branch of the power output 42 from the voltage regulator 32 to the second switching element S2. In the direction of a charging current I₁ or I₂ flowing to the battery bay 21, 22, the connection of the power outputs 41 and 42 via the third switching element S3 lies before the switching elements S1 and S2. It can be expedient in principle to position the switching element S3 after the switching elements S1 and S2 and to perform corresponding adjustments in the circuit diagram.

In the embodiment shown in FIG. 3, the switching elements S1, S2, and S3 form a switching device 5. The switching elements S1, S2, and S3 of the switching device 5 are controlled by the control unit 10. For this purpose, the control unit 10 is connected via control lines 11, 12, 13 to the individual switching elements S1, S2, and S3.

If the switching element S1 is closed, the first voltage regulator 31 feeds a first, in particular maximum charging current I₁ via its power output 41 to the battery bay 21. If the voltage regulator 31 provides a charging power having a charging current of, for example, 12 A, a battery pack inserted into the battery bay 21 is charged at 12 A.

If the switching element S2 is closed, the second voltage regulator 32 feeds a second, in particular maximum charging current I₂ via its power output 42 to the battery bay 22. If the voltage regulator 32 provides a charging power having a charging current of, for example, 12 A, a battery pack inserted into the battery bay 22 is charged at 12 A.

There is the option via the third switching element S3 of connecting the power outputs 41 and 42 of the voltage regulators 31 and 32 to one another and of feeding a charging power to only one battery bay 21 or 22. If, for example, the switching element S1 and the switching element S3 are closed, in total a charging power having a charging current is fed to the battery bay 21, which is composed of the charging current I₁ of the voltage regulator 31 and the charging current I₂ of the voltage regulator 32. A battery pack inserted into the battery bay 21 can be charged using an elevated charging current I₁+I₂, for example twice 12 A, thus 24 A.

A permissible maximum charging current can be provided by a voltage regulator 31, by two voltage regulators 31 and 32, or also by more than two voltage regulators. The charger can thus also include more than two battery bays for charging more than two battery packs.

Each of the chargers 1 shown in FIG. 1 to FIG. 3 is capable of carrying out charging of the battery packs 3 and 4 inserted into the battery bays 21 and 22 according to a selected method. The first battery pack 3 can thus be charged via the first interface 23 and the second battery pack 4 can be charged via the second interface 24 using a first charging power or using a second charging power. A first charging power for charging the first battery pack 3 is fed to the first interface 23, wherein the first charging power can be greater than the second charging power.

The controller 10 detects at least one operating parameter of the active charging procedure at the first interface 23 and compares it to a limiting value. In particular the inflowing actual value of the charging current I₁ is detected as an operating parameter of the active charging procedure of a battery pack 3, 4. This operating parameter, advantageously the actual value of the charging current I₁, is compared in the controller 10 to a limiting value I_{G}. Depending on the result of the comparison, the second charging power is fed to the second interface 24 to charge the second battery pack 4.

It is thus provided in particular that the controller 10, if the actual value I₁ of the charging current at the first interface 23 falls below the stored limiting value I_{G}, feeds a second charging power to the second interface 24. Rapid charging of both battery packs 3, 4 inserted into the battery bays 21, 22 can be achieved by this method.

Via the operating data, the controller 10 receives the information about a permissible maximum charging current Imax of the first battery pack 3 connected to the first interface 23. The controller 10 will set the charging power to charge the first battery pack 3 at up to its permissible maximum charging current Imax. It can be provided that the second interface 24 is fed a residual charging power if the fraction of the total charging power provided by the power electronics unit 30 required to charge the first battery pack 3 at the interface 23 with up to the permissible maximum charging current Imax is less than just this total charging power provided by the power electronics unit.

If, for example, a maximum permissible charging current I₁ is fed to the first battery pack 3 at the first interface 23, only a residual charging power can be output on the second interface 24 of the second battery bay 22 having the second battery pack 4, if a residual charging power is available. Due to the monitoring of the charging current I₁ flowing to the first battery pack 3 and a comparison to a current limiting value I_{G}, a charging power can then already flow to the second interface and therefore the second battery pack 4 when only reduced charging power is retrieved at the first interface 23.

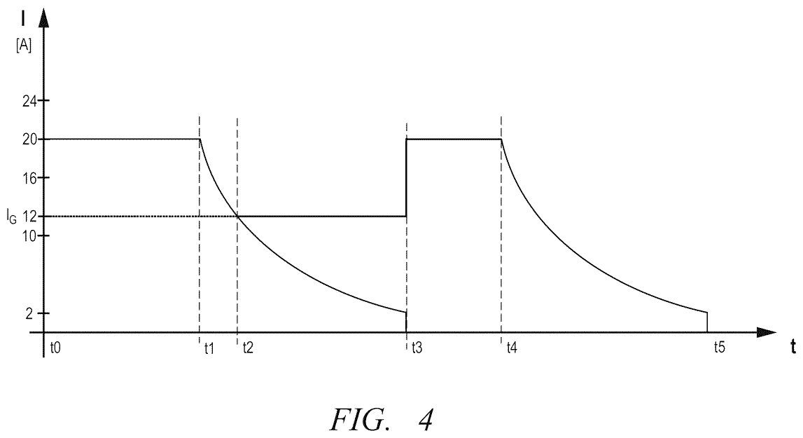

If the actual value of the charging current I₁ at the first interface 23 falls below the limiting value I_{G} stored in the controller 10, a charging power for charging the second battery pack 4 is fed to the second interface 24. This is illustrated in FIG. 4 in the schematic diagram of the current I over the time t. The principal shown is only described with one limiting value for the sake of simplicity. In principle, multiple limiting values can also be provided connected to a respective, for example step-by-step adjustment of the fed charging powers. In a further embodiment, a dynamic distribution of the charging power having arbitrarily many support points and without limiting values can also be expedient. A simple controller can also be solely time-controlled, according to which the distribution of the charging power is adjusted after a predetermined time span.

In the embodiment illustrated in FIG. 4, in a first time interval t0 to t1, for example, an in particular constant charging current I of, for example, 20 A is output on the first interface 23. In this first time interval t0 to t1, the first battery pack 3 is charged using a constant charging current (CC—constant current). At time t1, the further charging of the first battery pack 3 takes place with constant voltage (CV—constant voltage). In the charging phase CV, the charging current I drops in the time interval t1 to t3. During the drop of the charging current I in the time interval t1 to t3 (CV), the charging current I₁ falls below the limiting value I_{G} of the charging current stored in the controller 10 at time t2. Upon falling below the limiting value I_{G}, a charging current I₂ is fed to the second interface 24 (CC), since in the CV charging phase of the first battery pack 3, a sufficient charging power of the charger 1 is available due to the dropping charging current I₁. From time t2, upon falling below the limiting value I_{G}, the second battery pack 4 is already charged using a charging current I₂ in the charging method CC. Therefore, the method does not wait until time t3 until the first battery pack 3 in the first battery bay 21 is completely charged. During the charging time t of the battery packs 3, 4, the entire charging power using a maximum charging current I_{Lmax} of the charger 1 can be used. The charging time of the second battery pack 4 at the interface 24 in the second battery bay 22 can therefore be reduced.

If the first battery pack 3 is completely charged at the time t3, an increased charging current I₂ is fed to the second battery pack 4, which is indicated as 20 A by way of example in FIG. 4. Up to time t4, the second battery pack 4 is charged in the charging method CC. At time t4, the charging method is changed to CV and the battery pack 4 is completely charged up to time t5. The total charging time t0 to t5 of the battery packs 3 and 4 is significantly shorter than if both battery packs 3 and 4 are charged one after the other, thus sequentially.

The limiting value I_{G} of the charging current can be set according to selected criteria. The charging power fed to the second interface 24 for charging the second battery pack 4 can thus already be increased if the first battery pack 3 connected at the first interface 23 is charged by more than 50%. Alternatively, the current limiting value I_{G} can be set so that the battery pack 4 connected at the second interface 24 is already fed a charging power or an elevated charging power when the first battery pack connected at the first interface 23 is charged by more than 80%, in particular by more than 90% or 98%, very particularly by more than 99%.

In an embodiment of the method, it can be provided that the state of charge of the battery packs 3 and 4 connected to the interfaces 23 and 24 is detected. The state of charge of a battery pack 3, 4 is determined by the controller 10 from the received operating data, as described in detail above. The controller 10 determines the charging power flowing to a battery pack 3 or 4 depending on a comparison of the determined states of charge of the battery packs 3 and 4. Initially the battery pack 3 or 4 is thus expediently charged using an elevated charging power, which has the greater remaining charge. The charging power fed to the second battery pack is reduced according to the above-described methods. It is thus possible, after the two battery packs 3 and 4 are inserted into the battery bays 21 and 22, for a battery pack 3 or 4 which is completely charged to be able to be provided to the user in a short time.

To ensure gentle charging of the battery packs 3 and 4, it is provided that the temperature T of a battery pack 3, 4 connected to an interface 23, 24 is detected. The charging power output at the interface 23, 24 is lowered or set to “zero” if the temperature T of the battery pack 3 or 4 located in the state of charge is outside a predetermined temperature range. As already stated above, a medium can be fed to cool or to heat the battery pack 3 or 4, for example an air flow 9 via a fan.

The decision of which of the battery packs 3 or 4 inserted into the battery bays 21 and 22 is preferably to be charged can also be specified by the user. It can thus be provided that the controller 10 detects, for example via the communication connection 6 or 7, the time t_{A} when a first battery pack 3 or 4 is connected to one of the interfaces 23 or 24. For simplified description of the method, the first battery pack 3 is connected hereinafter to the first interface 23 at a first time t_{A}. The “first” battery pack can also be the battery pack 4 connected to the interface 24.

The controller 10 also detects, for example via the communication connection 7, when the second battery pack 4 is connected to the second interface 24 at a second time tp. After the connection of the battery packs 3 and 4 to the interfaces 23 and 24, the first battery pack 3 can be charged via the first interface 23 and the second battery pack 4 via the second interface 24.

The controller 10 checks whether a time span Δt has passed or not after the connection of the first battery pack 3 to the first interface 23. Depending on the detected times t_{A} and t_{B} and the predetermined time span Δt, the controller 10 will output the charging power on the first interface 23 to charge the first battery pack 3 and/or on the second interface 24 to charge the second battery pack 4.

If the first time t_{A} is before the second time t_{B} by more than the predetermined time span Δt, the first battery pack 3 is primarily charged. Primarily charged is to express that the first battery pack 3 is preferably charged.

If a user plugs a first battery pack 3 at a first time t_{A} into the battery bay 21, the controller can start a timer which runs for a time span Δt. If the timer or the time span Δt has expired and the user then connects the second battery pack 4 to the interface 24, the first battery pack 3 is primarily charged. If the user connects the second battery pack 4 at a time t_{B} to the interface 24, at which the timer has not yet expired, the controller 10 will charge both plugged-in battery packs 3 and 4 equitably, in particular will charge them simultaneously. The condition for which the first battery pack 3 is primarily charged can be formulated as follows:

$$Δ t < {t}_{B} - {t}_{A}$$

The first battery pack 3 and the second battery pack 4 are charged if the second time t_{B} lies within the predetermined time span Δt after the first time t_{A}.

The predetermined time span Δt is expediently in a range from 0 seconds to 1 minute. A range from 0.1 seconds to 20 seconds or a range from 0.5 seconds to 10 seconds is preferred. The predetermined time span Δt is very particularly 5 seconds.

If the first battery pack 3 is primarily charged, the controller 10 will detect the permissible maximum charging current Imax of the first battery pack 3 connected to the first interface 23 and primarily feed the charging power to charge the first battery pack 3 using up to its maximum charging current Imax.

The second interface 24 will only be fed a charging power if the fraction of the total charging power of the power electronics unit 30 required for charging the first battery pack 3 at the first interface 23 using up to its maximum charging current Imax is less than the total charging power provided by the power electronics unit 30 having the maximum charging current I_{Lmax}. A residual charging power is fed to the second interface 4 if the total charging power of the power electronics unit 30 is higher than the charging power required by the first interface 23.

The monitoring of a battery pack 3 and 4 in the state of charge is also advantageous in this method in order to ensure a long service life of the battery packs 3, 4. As already described above, it is provided that the temperature T of a battery pack 3, 4 connected to an interface 23, 24 is detected. The charging power output at the interface is lowered or set to “zero” if the temperature of the battery pack 3 or 4 located in the state of charge is outside a predetermined temperature range. A medium can be fed to the battery bay 21, 22, for example an air flow 9 via a fan, for cooling or heating the battery pack 3 or 4.

It can also be provided in this method that the state of charge of the battery packs 3 and 4 connected to the interfaces 23 and 24 is detected. The controller 10 determines the charging power flowing to a battery pack 3 or 4 depending on a comparison of the determined states of charge of the battery packs 3 and 4. Expediently, the battery pack 3 or 4 is initially charged using an elevated charging power which has the greater remaining charge. The charging power fed to the second battery pack is reduced according to the above-described methods.

The controller 10 of the charger 1 shown in FIGS. 1 to 3 includes a microprocessor having a stored computer program, which includes commands to carry out one or more of the method steps of the above-described methods depending on received operating data. The computer program is expediently stored on a medium, such as a storage card or the like. The medium can be read by the microprocessor via a read unit.

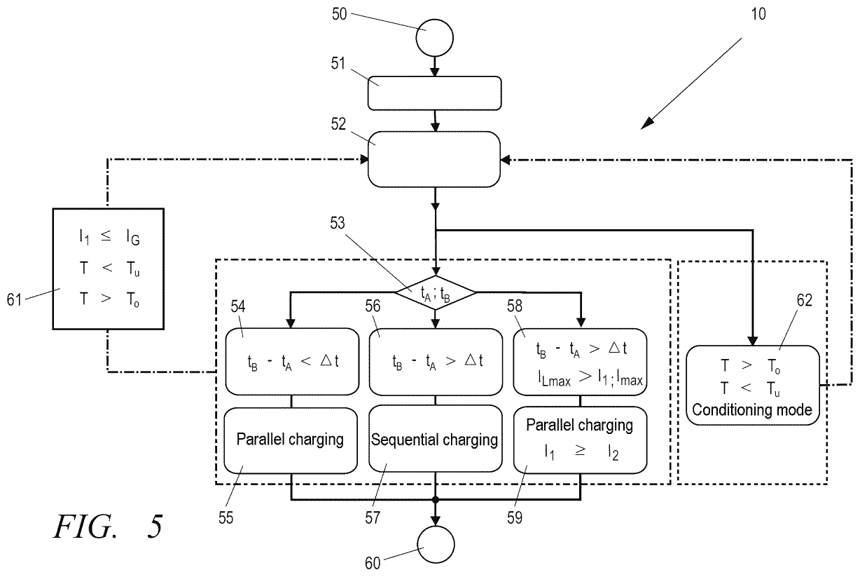

FIG. 5 schematically shows the method for selecting a battery pack 3 or 4 to be primarily charged depending on the time t_{A}, t_{B} of its connection to the assigned interface 23, 24.

With the start 50, a first battery pack 3 is connected to the first interface 23 and/or a second battery pack 4 is connected to the second interface 24. The plugging of a battery pack 3, 4 into a battery bay 21 or 22 and its connection to the interface 23 or 24 is recognized in particular due to the change of the voltage level occurring at the interface 23 or 24. This step 51 of the method immediately follows the start 50.

In block 52 in FIG. 5, the communication takes place via the communication connection 6 and 7 with the plugged-in battery packs 3, 4. Operating data and/or characteristic data of the plugged-in battery pack 3 and 4 are retrieved via the communication connection 6 and 7 and processed in the control unit 10. The operating data and/or characteristic data of the battery pack 3, 4 can be its chemical structure, its capacitance, its maximum charging current, its maximum charging voltage, its present charging current, is present charging voltage, its present temperature, or the like.

At the same time, the time t_{A} of the connection of the first battery pack 3 to the first interface 23 and the time t_{B} of the connection of the second battery pack to the second interface 24 are detected.

The rhomboid 53 shows the step of the evaluation of the times t_{A} and t_{B} and possibly further operating parameters.

If both the first battery pack 3 and the second battery pack 4 are plugged in within the time span Δt, both battery packs 3 and 4 are charged simultaneously, as shown by blocks 54 and 55 of the schematic flow chart. This simultaneous or parallel charging of the battery pack 3 and 4 takes place if the following condition is met:

$${t}_{B} - {t}_{A} < Δ t .$$

If the first battery pack 3 is plugged in and the second battery pack 4 is only plugged in after expiration of the time span Δt, the plugged-in battery packs 3 and 4 are charged one after another, thus sequentially, as shown by blocks 56 and 57 of the schematic flow chart. This successive or sequential charging of the battery packs 3 and 4 takes place if the following condition is met:

$${t}_{B} - {t}_{A} > Δ t .$$

In this case, the battery pack 3 plugged in first is charged preferably, thus primarily. The expression “primarily charged” is to express that the first battery pack 3 is charged using a maximum charging current Iₘₐₓ—permissible according to the operating data.

In this case, the charging current I₁ requested by the first battery pack 3 can correspond to the maximum charging current I_{Lmax} which can be provided by the power electronics unit 30 of the charger 1 at most. At this time, the second plugged-in battery pack 4 is not charged.

If the charging current I₁ flowing to the first battery pack 3 is less than the maximum charging current I_{Lmax}, provided by the power electronics unit 30, the second battery pack 4 can also be charged during the charging procedure of the first battery pack 3. This state is schematically reflected in blocks 58 and 59 of the flow chart. The first battery pack 3 is primarily charged; a higher charging current can thus initially flow to the first battery pack, so that initially I₁≥I₂ applies. In contrast, if the first battery pack 3 only requests a maximum charging current of, for example, 4 A, a higher charging current is available to the second battery pack 4, so that then I₁<I₂ occurs.

It can also be advantageous, upon switching of the charging procedure from CC to CV during the charging procedure of the first battery pack 3, to feed the charging power which becomes free to the second battery pack 4, in order to already charge it although the first battery pack 3 is not yet completely charged. The charging of the second battery pack 4 can take place according to the schematic diagram in FIG. 4.

If the battery packs 3 and 4 are charged, the end 60 of the schematic flow chart in FIG. 5 is reached.

It can be expedient to cyclically request the operating parameters of the battery pack 3, 4 and/or the operating parameters of a running charging procedure, as shown in block 61. If, for example, the charging current I₁ to the first battery pack 3 is below a limiting value I_{G} stored in the controller 10, a charging current I₂ can already be fed to the second battery pack 4 and therefore the second battery pack 4 can already be charged, although the battery pack 3 to be primarily charged is not yet completely charged. This shortens the charging time of the second battery pack 4.

The temperature T of the battery pack 3, 4 can also be monitored, in particular cyclically. If the temperature T of the battery pack 3, 4 reaches or exceeds an upper limiting temperature To, a running charging procedure is terminated. It is then again checked via block 52 and rhomboid 53 which of the plugged-in battery packs 3 and 4 is being charged. In this way, it can also be checked whether the temperature T of the battery pack 3, 4 is below a permissible lower limiting temperature Ty. This can be the case, for example, in outdoor use under winter conditions.

Before the start of a charging procedure, it can be checked whether the battery pack 3 and/or 4 to be charged is in a permissible temperature range from Tᵤ to Tₒ. Such a temperature range can be between +15 to +45°.

If the controller 10 establishes that the temperature T of a battery pack 3, 4 lies outside the predetermined temperature range Tᵤ to Tₒ, expediently a so-called “conditioning mode” can be carried out, as shown in block 62. In the “conditioning mode”, a medium is fed to the battery bay 21 or 23, using which a battery pack 3 or 4 inserted into the battery bay 21 or 22 can be cooled or heated. A fan is indicated as an example in FIG. 1 to FIG. 3, using which a cooling or heating air flow 9 is fed to a battery bay 21 or 22. If the battery pack 3, 4 is again within the predetermined temperature range Tᵤ to Tₒ, the readiness for charging is reported at block 52 and the sequence branches to rhomboid 53.

It is understood that the foregoing description is that of the preferred embodiments of the invention and that various changes and modifications may be made thereto without departing from the spirit and scope of the invention as defined in the appended claims.

1. A method for charging a first battery pack and a second battery pack using a charger, wherein the charger includes a first interface, a second interface, at least one power electronics unit for providing a charging power at least at one of the first interface and the second interface, and a controller, the controller being configured to detect that the first battery pack is connected to the first interface at a first time and to detect that the second battery pack is connected to the second interface at a second time, at least one of: the first battery pack is charged via the first interface and the second battery pack is charged via the second interface; the method comprising:
controlling, via the controller, the at least one power electronics unit depending on a detected first time and a detected second time and a predetermined time span such that the charging power is output on at least one of the first interface to charge the first battery pack and on the second interface to charge the second battery pack, wherein primarily the first battery pack is charged if the first time is before the second time by more than the predetermined time span.

2. The method of claim 1, wherein the first battery pack and the second battery pack are charged if the second time lies within the predetermined time span after the first time.

3. The method of claim 1 further comprising:
detecting, via the controller, a permissible maximum charging current of the first battery pack connected to the first interface; and,
feeding, via the controller, the charging power primarily for charging the first battery pack, using up to a maximum charging current of the first battery pack, to the first battery pack if the first time is before the second time by more than the predetermined time span.

4. The method of claim 1 further comprising:
feeding a residual charging power to the second interface if a fraction of the charging power required to charge the first battery pack, using up to a maximum charging current of the first battery pack, is less than a total charging power provided by the power electronics unit.

5. A method for charging a first battery pack and a second battery pack via a charger, wherein the charger includes a first interface, a second interface, at least one power electronics unit for providing a charging power at least at one of the first interface and the second interface, and a controller, the first battery pack being charged via the first interface and the second battery pack being charged via the second interface with a first charging power or a second charging power, wherein the first charging power is greater than the second charging power, the method comprising:
feeding the first charging power for charging the first battery pack to the first interface;
detecting, via the controller, at least one operating parameter of an active charging procedure at the first interface;
comparing the at least one operating parameter to a limiting value stored in the controller; and,
feeding, via the controller, the second charging power to the second interface to charge the second battery pack depending on a result of said comparing the at least one operating parameter to the limiting value.

6. The method of claim 5, wherein the controller detects as the at least one operating parameter of the active charging procedure an actual value of a charging current flowing to a battery pack and compares it to the limiting value stored in the controller, wherein the stored limiting value is a current limiting value.

7. The method of claim 6, wherein the controller feeds the second charging power to the second interface if the actual value of the charging current falls below the stored limiting value.

8. The method of claim 5, wherein a residual charging power is fed to the second interface if a fraction of a total charging power provided by the power electronics unit required for charging the first battery pack using up to a permissible maximum charging current is less than the total charging power provided by the power electronics unit.

9. A method for charging a first battery pack and a second battery pack via a charger, wherein the charger includes a first interface, a second interface, at least one power electronics unit for providing a charging power at least at one of the first interface and the second interface, and a controller, the method comprising:
charging the first battery pack via the first interface and the second battery pack via the second interface;
detecting, via the controller, operating data to determine a remaining charge of the first battery pack connected to the first interface and of the second battery pack connected to the second interface;
comparing, via the controller, the detected operating data of the first battery pack and the second battery pack with one another; and,
primarily charging, via the controller, a respective one of the first battery pack and the second battery pack having a greater remaining charge after evaluation of said comparing of the detected operating data.

10. The method of claim 9, wherein the controller detects a permissible maximum charging current of the first battery pack connected to the first interface and the second battery pack connected to the second interface, and the controller primarily feeds the charging power for charging the respective one of the first battery pack and the second battery pack having the greater remaining charge.

11. The method of claim 9 further comprising feeding a residual charging power to the second interface if the fraction of a total charging power provided by the power electronics unit required for charging the first battery pack, using up to a permissible maximum charging current, is less than the total charging power provided by the power electronics unit.

12. The method of claim 9, wherein the operating data includes amounts of energy to be absorbed by the first battery pack and the second battery pack per unit of time, and the controller primarily charges a respective one of the first battery pack and the second battery pack having a greater amount of energy to be absorbed per unit of time.

13. The method of claim 9, wherein the operating data includes a temperature of a corresponding one of the first battery pack and the second battery pack connected to a corresponding one of the first interface and the second interface, and the controller only feeds a charging power to the corresponding one of the first interface and the second interface if the temperature of the corresponding one of the first battery pack and the second battery pack is within a predetermined temperature range.

14. The method of claim 9, wherein the controller interrupts a running charging procedure if a temperature of a respective one of the first battery pack and the second battery pack is outside a predetermined temperature range, and the controller continues the charging procedure if the temperature is again within the predetermined temperature range.

15. The method of claim 9, wherein the controller maintains a charging procedure set once until a complete charging of the respective one of the first battery pack and the second battery pack having the greater remaining charge.

16. The method of claim 9, wherein the controller updates operating parameters of the first battery pack and the second battery pack after a predetermined time span and adjusts the charging power fed to the first interface and the second interface according to the updated operating parameters.

17. A charger comprising:
a first interface for charging a first battery pack;
a second interface for charging a second battery pack;
a power electronics unit for providing a charging power;
a controller configured to detect that the first battery pack is connected to said first interface at a first time and to detect that the second battery pack is connected to said second interface at a second time; and,
said controller being further configured to control said power electronics unit depending on the detected first time and the detected second time and a predetermined time span such that the charging power is output on at least one of said first interface to charge the first battery pack and on said second interface to charge the second battery pack, wherein primarily the first battery pack is charged if the first time is before the second time by more than the predetermined time span.

18. The charger of claim 17, wherein said power electronics unit includes at least one DC/DC converter, the DC/DC converter is connected to one of said first interface and said second interface, and is configured to set the charging power to the one of said first interface and said second interface to which the DC/DC converter is connected.

19. The charger of claim 17, wherein said power electronics unit includes a first DC/DC converter connected to said first interface and a second DC/DC converter connected to said second interface; said first DC/DC converter is configured to set the charging power to said first interface; and, said second DC/DC converter is configured to set the charging power to said second interface.
